(19) United States
(12) Patent Application Publication
(10) Pub. No.: US 2004/0140643 A1
(43) Pub. Date: Jul. 22, 2004

(54) Horse speeding vehicle

(76) Inventor: Maximo Gomez, New York, NY (US)

Correspondence Address: JENNIFER MEREDITH, MEREDITH & KEYHANI PLLC, 315 PARK AVENUE SOUTH, 19th FLOOR, NEW YORK, NY, 10010, US

(21) Appl. No.: 10/348,380

(22) Filed: Jan. 21, 2003

(51) Int. Cl. B62M 1/04

(52) U.S. Cl. 280/252

(57) ABSTRACT

A system and method for increasing the velocity of an animal on a mechanical device using gravity and natural animal movement. According to a preferred embodiment, there may be a frame; six wheels rotatably attached to the frame; four foot links coupled to four of the six wheels; four foot supports connected to at least one foot link; and a coupling system in rotational communication with at least one foot link to translate the stepping motion of a horse into angular momentum. The coupling system may have at least one gear connected, by a chain, to another at least one smaller sized gear to increase the velocity. Different sized gears may be used to control the speed of the vehicle.

### BACKGROUND OF THE INVENTION

The present invention generally relates to animal-powered vehicles. Prior art within this realm are vast throughout industry. Included may be any mechanism that directly utilizes the motive power of an animal to facilitate human transportation.

Generally, horse drawn vehicles have heretofore been capable of traveling only as fast as the horse. Since ancient times, it has been known to utilize a single shaft horse-drawn vehicle where the shaft is attached to the horse by a neck collar. Improvements to this included a harness articulated to a small saddle about a vertical axis of articulation, a shaft mounted on a small saddle in a semi-rigid fashion and a single shaft mounted on a traction cradle connected to a harness. U.S. Pat. No. 5,410,863 discloses a harness device for a horse-drawn vehicle.

Well-known examples of this within the art may include horse-drawn carriages, racing sulkies, and hitch carts. U.S. Pat. No. 5,076,041, issued to Proust, discloses a typical hitch for a single shaft horse-drawn vehicle. As discussed in the '041 patent, single shaft horse- drawn vehicles place a good deal of strain on the horse, and may cause sores and rubbing. Further, such technology does not mechanically address utilizing animal transportation as a productive, cost-efficient means of transportation. Relevant prior art also lacks the applied technology to raise the raw speed of horses while still operating as a mode of efficient transportation, comparable to automobiles.

Also related to the present invention are mechanisms primarily used to modify the motive power of horses (and other animals) in order to gain some mechanical advantage. U.S. Pat. No. 4,078,829 issued to Davis discloses a racing sulky. Key to the '829 patent, and much of the prior art, is the idea of altering, in some form, the forward motion of the horse to generate a more useful means of power, including the use of gear trains and pulley systems to alter the mechanical advantage of the system. However, such systems are only capable of going as fast as the horse will carry them.

Despite the extent of known prior art in this field, a demand still exists in certain areas for a mechanism, which can enhance the efficiency and productivity of animal driven transportation. The new concept is to use the natural movements of flexion and extension of the legs of the animal and the force produced by the animal's gravity to move a spinning mechanism that multiply the animal's speed. This new device will have multiple uses as transport of humans and cargo by ground or water and several applications in touristy, acquatic and horse racing sports. Also not previously addressed is the employment of technology to harness the motive power of horses (and certain other animals) to its fullest extent. Further, a need exists to provide a non-motorized method of transportation that is capable of use on both land and water.

### SUMMARY OF THE INVENTION

The present invention provides a system and method for increasing the velocity of an animal on a mechanical device using gravity and natural animal movement of it's legs. According to one embodiment of the present invention, a horse drawn ground vehicle for carrying a passenger is disclosed comprising: a frame configured to be supported on the ground by at least three wheels rotatably attached to the frame, which may have shock absorbers to provide further support; at least one foot link coupled to at least three wheels, wherein each foot link has a first end and a second end; at least four foot supports for receiving the hoofs of a horse in standing position, the foot supports supported by at least one foot links; at least one coupling system in rotational communication with at least one said foot link to translate the stepping motion of a horse into angular momentum; and at least one seat. There may also be a chain connecting a bigger gear system to a smaller gear in order to selectively alter the speed.

According to another embodiment of the present invention, a horse speeding ground vehicle for passengers is disclosed, the vehicle comprising: a frame configured to be supported on the ground by six wheels rotatably attached to the frame; four foot links coupled to the four of the six wheels, wherein each foot link has a first end and a second end; four foot supports for receiving the hoofs of a horse in standing position, the foot supporting portion supported by at least one foot links; and two coupling systems in rotational communication with at least one foot link to translate the stepping motion of a horse into angular momentum.

According to yet another embodiment, a horse drawn water vehicle for carrying a passenger is disclosed comprising: a frame configured to be supported on the water with at least one water pedal attached to the frame; at least one foot links coupled to at least one water pedal, wherein each foot link has a first end and a second end; at least four foot supports for receiving the hoofs of a horse in standing position, the foot supports supported by at least one foot links; at least one coupling system for coupling each foot link to a pivot axis so that a first end of each foot link travels in a closed path relative to a pivot axis, the coupling system being in rotational communication with at least one said foot link to translate the stepping motion of a horse into angular momentum to the pivot axis. There may also be a chain connecting a bigger gear system to a smaller gear in order to selectively alter the speed.

According to still yet another embodiment, a method of providing an efficient, motorless personal vehicle is disclosed, comprising; providing a frame, wherein the frame is supported by at least three wheels; coupling at least one foot link to at least one wheel; providing at least four foot supports, wherein at least one foot support is in fixed communication with a foot link; and providing at least one coupling system in rotational communication with at least one said foot link to translate the stepping motion of a horse into angular momentum.

These and other features, aspects and advantages of the present invention will become better understood with reference to the following drawings, description and claims.

### BRIEF DESCRIPTION OF THE DRAWINGS

FIG. 1 is a front view of a horse powered vehicle, according to an embodiment of the present invention;

FIG. 2 is a rear view of a preferred embodiment;

FIG. 3 is a side view of the points of restraint of the animal provided by the frame;

FIG. 4 is a detailed side view of a coupling system according to one embodiment of the present invention;

FIG. 5 is a front view of a horse speeding vehicle according to the present invention;

FIG. 6 is a side view of a horse speeding vehicle according to one embodiment of the present invention;

FIG. 7 is a top view of a horse speeding vehicle according to one embodiment of the present invention;

FIGS. 8A-J depict a horseshoe as used in accordance with the present invention;

FIG. 9 depicts a side view of the progression of movement according to one embodiment of the current invention;

FIG. 10 depicts an elevational view of a horse powered water vehicle as in the present invention; and

FIG. 11 depicts a method according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention discloses a vehicle powered by an animal of four legs. This invention may be used for the transportation of persons. Also, the present invention may be used for recreational purposes. This vehicle may comprise a frame and at least three wheels attached rotatably to the frame. There may be at least two foot supports, in rotational communication with the wheels of the vehicle. It should be understood that many different embodiments are envisioned, including both land and water vehicles.

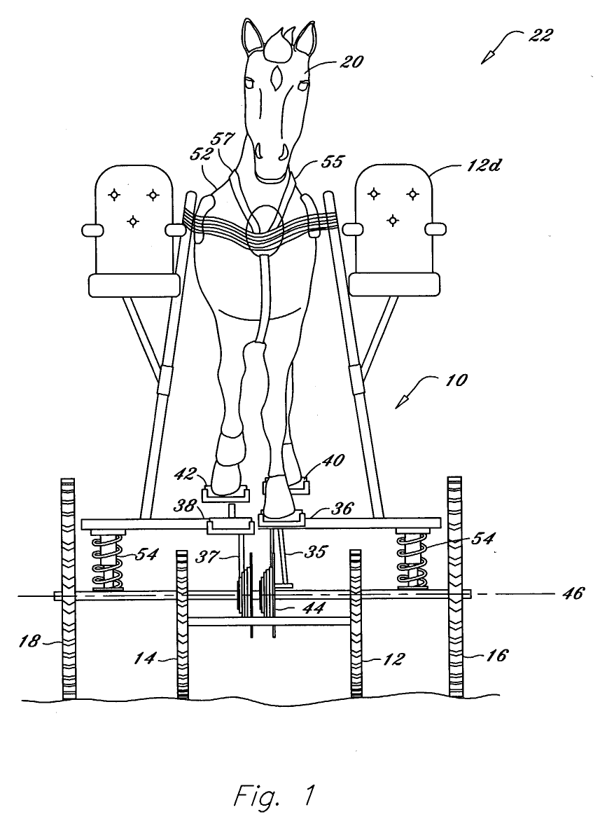

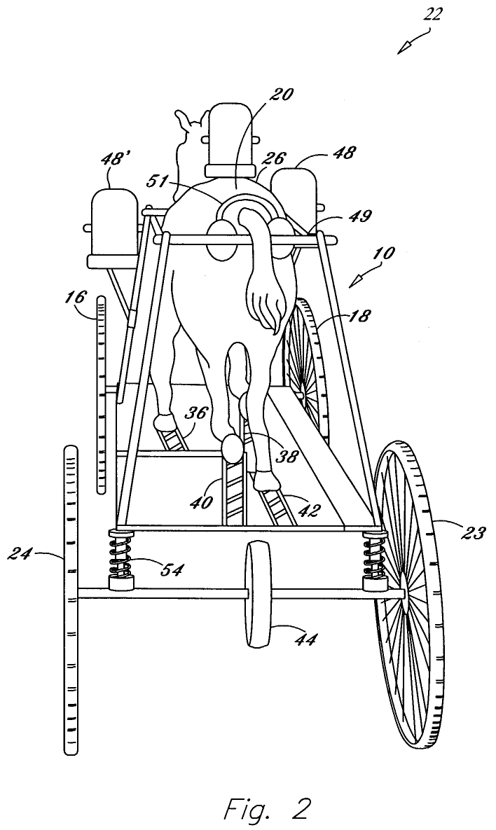

FIGS. 1-3 depict a horse 20 drawn vehicle 22 for carrying passengers according to the present invention. As shown the frame 10 is configured to be supported on the ground by six wheels. It should be understood that there may be anywhere from three to thirty wheels. Also, there may be more than one horse. As shown, front left wheel 12, front right wheel 14, a middle left wheel 16, middle right wheel 18, rear left wheel 21 (FIG. 2) and rear right wheel 23 (FIG. 2) are rotatably attached to the frame 10. There are four foot links. Front left foot link 35 and front right foot link 37 coupled to the front two wheels, front left wheel 12 and front right wheel 14. Each foot link has a first end and a second end. The front left foot link 35 has a first end coupled to the front left wheel 12, and a second end fixed to foot support 36. Front right foot link 37 has a first end coupled to the front right wheel 14 and a second end fixed to foot support 38. The foot supports (e.g. 36, 38, 40, 42) may act as pedals. They may also merely act to support the horse, and not actually be in driving communication with the wheels. At least one foot support, though, should be in driving communication with the wheels. There should be at least four foot supports for receiving the hoofs of a horse 20 in standing position. It should be understood that the term coupled is used to describe that the first ends of each foot link are connected to the wheel, but are not necessarily directly fixed to the wheel. There may be a number of gears and translational bars coupling the first end to the wheel so as to rotationally translate and amplify the movement of the horse.

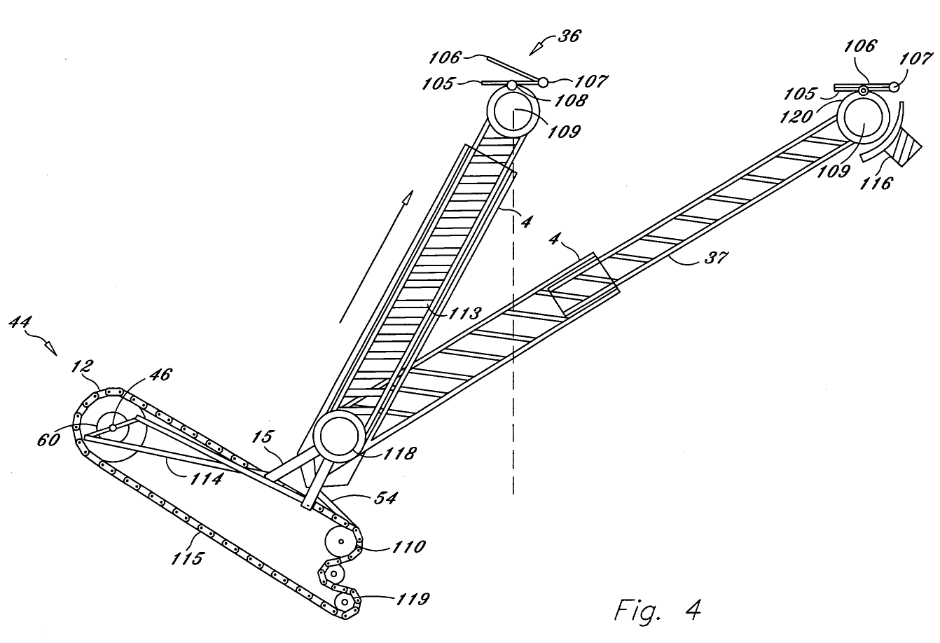

According to the embodiment shown, there are four foot supports: front left foot support 36, front right foot support 38, back left foot support 40, and back right foot support 42. A coupling system 44 couples the foot link 35 to the front left wheel 12 so that a first end of each foot link travels in a closed path relative to a pivot axis 46. FIG. 4 dpecits the pivot axis 47 and main axis with grater clarity. The coupling system 44 couples the first end of each foot link (e.g. 35) at a plurality of distances from the pivot axis 46 to alter the path of travel of the first ends of the foot links (e.g. 35) relative to the pivot axis 46. The coupling system 44 is in rotational communication with at least one of the foot links to translate the stepping motion of a horse into angular momentum. It may take a number of different forms, including gears, or merely a bar attached to the wheel to provide elliptical movement of the foot supports. The gears may be shifted and translate to engage different sets of wheels. According to a preferred embodiment, the coupling system is comprised of a first set of gears and a second set of gears. During the initial process of moving the vehicle, it may be desirable to have the first set of gears be the same size as or larger than the second set of gears. However, once there is movement of the vehicle, it may be desirable to have the second set of gears be larger than the first set of gears. The term larger, is intended to denote having a greater diameter. The gears should be unidirectional or reversible uni-directional. Reversible unidirectional is intended to denote gears that may be forward only and backward only. This is intended to prevent the animal from switching motions (forward and backward).

As shown, there may be at least one seat 48. The seat may also be a compartment for carrying goods rather than passengers. There may also be an attachment device for removably attaching the hoofs of horse to said foot supports. For example, the attachment device may consist of a first part attached as horseshoes to the animals hoofs and a second part for removably receiving the horseshoes so that they are attached to the foot support or pedal (e.g. 36). An aerodynamic cover may also be used (not shown). There may also be a restraint system 52 for stabilizing the horse 20 in the vehicle 22. Shock absorbers 54 may be used to cushion the weight of the horse 20 and the force of the horses 20 movement. Brakes (not shown) may also be used. The brakes would be in communication with the wheels.

As shown in FIG. 2, the frame 10 is designed to encase the horse 20. The rear portion 49 of the frame may rest at the ischium bone of the horse 20, which is just under the tail. The rear portion 49 may be like a gate, that opens and shuts, to encase the horse within the frame 10. There may be a number of cushions, such as pillow 51, to prevent rubbing or discomfort to the horse.

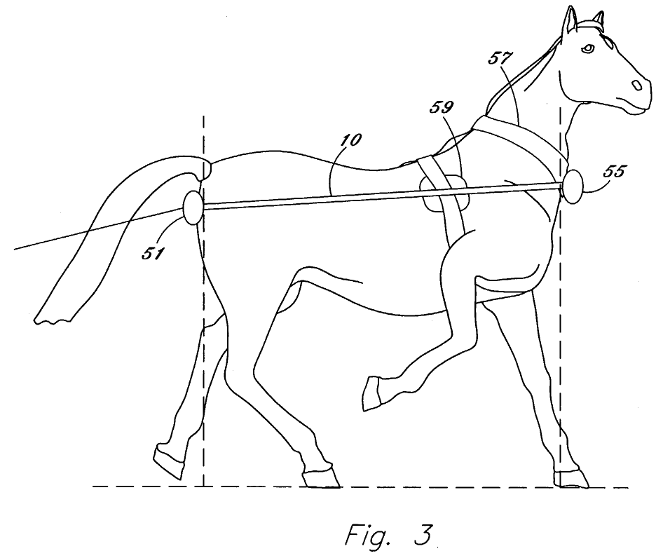

FIG. 3 depicts a portion of the frame 10 and restraints. As shown, ideally, there are pads or pillows at certain points to restrain the horse, yet prevent discomfort. As shown, there may be a frontal restraint 55, which may be in communication with a collar 57. There may be two laterals pillows, right side pillow 59 is visible. The rear pillow 51 is below the tail, resting upon the ischium bone of the horse 20.

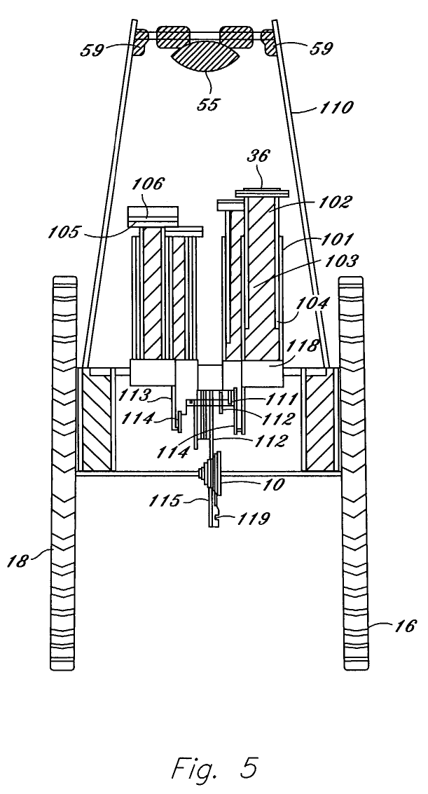

Referring to FIGS. 4 and 5, the foot support 36 may act to angle about the main axis 110, under controlled motion created from the horse 20. The main axis 110 may be supported by a portion of the frame 10. Foot support 36 may coupled to the wheel through a number of arms. As shown, there may be a first arm 37. The first arm 37 may have an outer tube 101 and an inner tube 102, with a spring 103 inside and ball bearings 104 between. This allows for easy and continuous movement of the vehicle through the horses motion. The first arm is attached to the bottom portion 105 of the horseshoe by attachment place 109 and hinge 108. The horseshoe acts as an attachment device to the foot support. The first arm 37 may have a base 118 that is connected to a short arm 113. The short arm 113 may be connected to a first portion 114 of the inducer. The first portion 114 of the inducer may be in communication with a second portion 111 of the inducer, which may be an elbow type connection. The second portion 111 of the inducer allows for the rotational translation of the horses movement about a pivot axis 46. As shown, the long arm 37 may be the area of contact of the horse 20, while the first portion 114 of the inducer may act to turn the second portion 111 of the inducer to generate rotation from the motion of the horse 20. In generating rotation of the coupling system 44, a ratchet may be used in connection with the chain 115 to allow the coupling system 44 to only rotate in a forward direction. Chain 115, in connection with the coupling system 44 and the pivot axis 46, acts to transfer rotational energy to the pivot axis 46. There may also be a mechanism 119 to change gears. A shock absorber 54 may also be utilized to cushion the movement of the long arm 37. The may also be a second shock absorber 116. According to a preferred embodiment, the gear that rotates about pivot axis 46 is at least two times the size of the gear that rotates about the main axis 110. This provides greater velocity. During the initial process of moving the vehicle, it may be desirable to have the gears that rotate about the main axis 110 be the same size as or larger than the gears that rotate about the pivot axis 46. However, once there is movement of the vehicle, it may be desirable to have the gears that rotate about the pivot axis 46 be larger than the gears that rotate about the main axis 110. The use of shifting gear mechanisms are known within the art and intended to be utilized in the present invention.

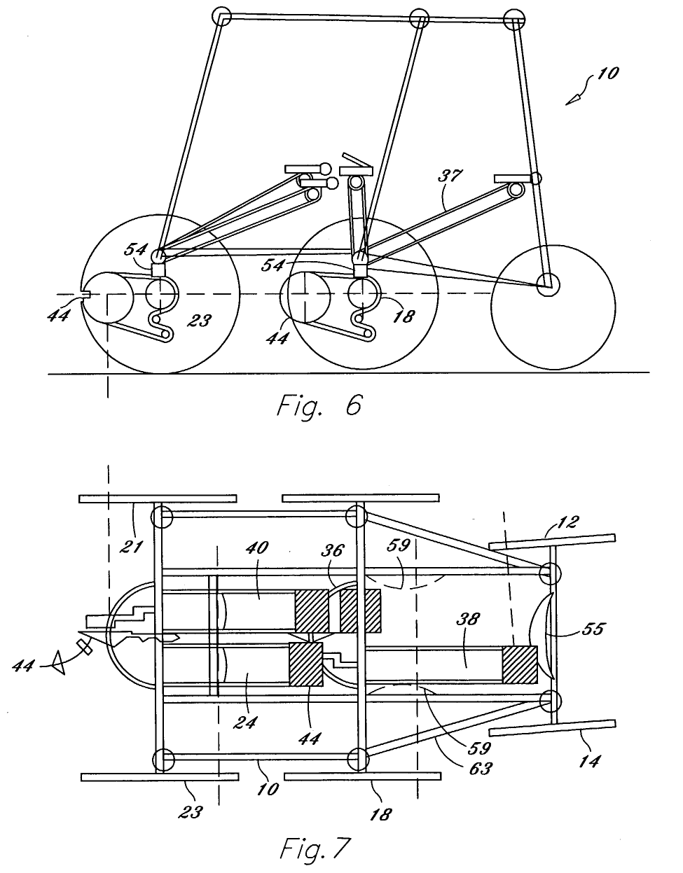

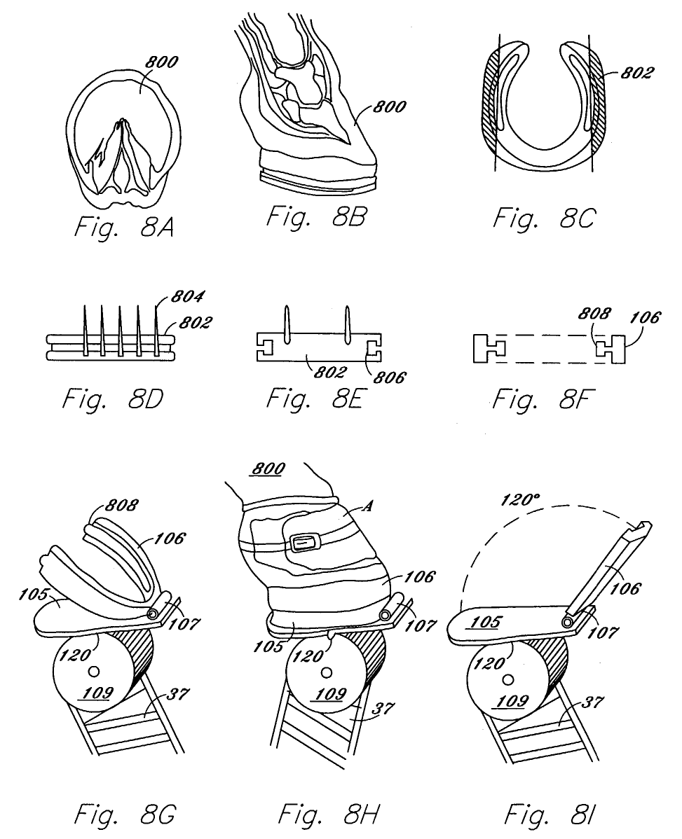

FIG. 6 depicts a side view according to an embodiment with six wheels. As shown, the front wheels 14 are used to steer the vehicle, while the rear wheels (18 and 23) are used to support the horse and the vehicle and provide movement.

FIG. 7 depicts a top view according to the present invention. As shown, the frame 10 may have bars 63 to steer the cart. The front left 12 and front right 14 wheels are used for steering. Also, as shown there are two coupling systems 44. A coupling system 44 for the middle wheel (16 and 18) and a coupling system 44 for the rear wheels (21 and 23). It should be understood, that there must be at least one coupling system 44 and that coupling system must be in rotational communication with at least one foot support (e.g. 36, 40, 42, 44).

FIGS. 8A-8I depict an embodiment of an attachment device, specifically a horseshoe for easy connection of the horses hoof to the foot support. FIG. 8A and 8B depict a horses hoof 800. FIGS. 8C, 8D and 8E depict a bottom, side and front view of the horseshoe 802. As shown, the horseshoe 802 may be attached to the horse's hoof 800 by nails 804. The horseshoe is shaped to have a receiving portion 806. Referring to FIG. 8F, the receiving portion 806 receives a protrusion 808 on the inside of the upper portion 106 of the horseshoe. The term foot support as claimed, may encompass a number of different embodiments. According to the embodiment shown, the foot support is comprised of the upper portion 106, hinge 120 and bottom portion 105. FIG. 8G depicts an elevational view of the horseshoe as attached to the arm 37. The bottom portion 105 of the horseshoe may be attached to the arm by a hinge 120. FIGS. 8H and 8I are intended to depict the range of motion. As shown, the top portion 106 and bottom portion 105 may be in communication. The top portion 106 may also be opened. When attached to the horse, the top portion 106 typically could only open 120 degrees from the bottom portion 105. It should be understood that there may be a number of different attachment devices to attach the hoof of a horse to a portion of the foot support (e.g. 105).

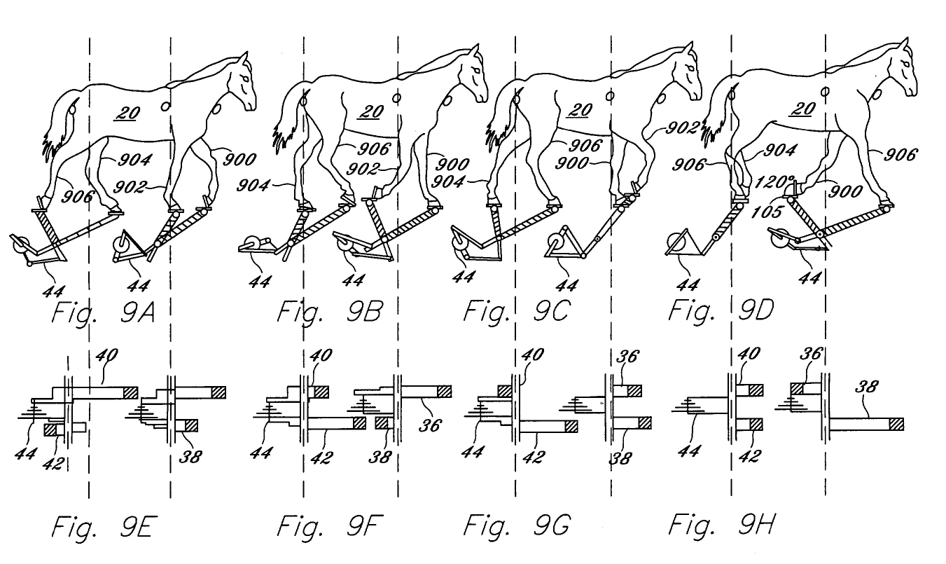

FIGS. 9A-9H depict the motion of the horse. FIGS. 9A-9D depict the motion of the horse required to turn the wheels 180 degrees. FIG. 9E-9H depicts the corresponding top views of the foot supports. FIG. 9E corresponds to FIG. 9A. FIG. 9F correspond to FIG. 9B. FIG. 9G corresponds to FIG. 9C. FIG. 9H corresponds to FIG. 9D. The horse 20 may start with the front left 900 foot raised forward and the right back 902 foot being raised. As shown in FIG. 9B, pressure may be placed on the front left 900 foot and left back 904 to start the wheels turning. The front left 900 leg is raised, the horseshoe opens, while hingedly attached to the bottom portion 105 of the horseshoe which acts as the foot support. Where the angle between the bottom portion 105 of the horseshoe and the top portion 106 of the horseshoe reaches approximately 120 degrees and the front left 900 foot is all the extended back, the wheels should have turned approximately 180 degrees. The motion is repeating with the right foot now being forward to provide an entire 360 degree rotation of the wheel.

Primarily, by action of the posterior femoral muscle, the right rear leg 906 of the horse is outstretched, but pending contraction. The motion of the right rear hoof 906, as controlled by the horse 20, is circular; to lift off from the rear end of the foot support 40 and land at the front end. This action is supported by the compression springs 103. Concurrent is the motion undergone by the left rear hoof 904 of the horse 20. Commencing at the front end of the foot support 42, the left rear hoof 904 of the horse 20 follows the natural stride of the horse 20. These two resultant motions, caused by the simultaneous movement of each foot support, alternate harmonically, driving the coupling mechanism 44. One such motion as described, results in a 180 degree turn of the coupling system. The two front foot supports 36, 38 function equivalently.

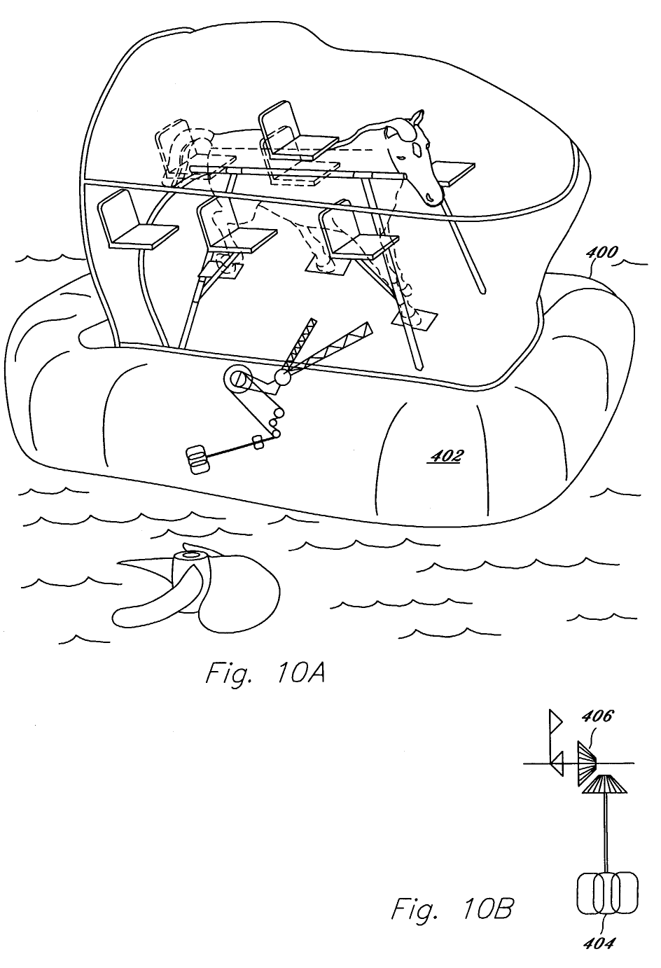

According to another embodiment, as shown in FIGS. 10A and 10B, a horse drawn water vehicle 400 for carrying a passenger is disclosed. The vehicle would be configured in a similar manner to the land vehicle. However, the frame 100 would float on the water with at least one water pedal 404 rotatably attached to the frame (instead of wheels). The frame may be supported by a simple inflated inner tube 402 around the outside of the frame. There may be at least two foot links coupled to at least one water pedal, wherein each foot link has a first end and a second end. There are at least four foot supports for receiving the hoofs of a horse in standing position, the foot supports supported by at least two foot links. This is to say that the vehicle may be powered by at least one foot. It is envisioned that at least one foot must be utilized to motor the vehicle (or be in driving communication). However, It is desirable to have all four feet in driving communication with the wheels. A coupling system may be used to couple each foot link to a pivot axis so that a first end of each foot link travels in a closed path relative to a pivot axis, the coupling system in rotational communication with at least one said foot link to translate the stepping motion of a horse into angular momentum; and at least one seat. The coupling system may be a system of gears, a bar in rotational communication with the water pedals or any combination thereof. FIG. 10B depicts the manner in which the coupling system may be used to turn pedal 404. It is envisioned that a system as shown in FIG. 4 would be utilized, with the main axis 110 turning the pedal 404 through a set of translation gears. First translation gear 406 being along the main axis 110 and second translation gear 408 turning the pedal. As in the previous embodiments, there may be at least one seat. The seat may also be a compartment for carrying goods rather than passengers. There may also be an attachment device for removably attaching the hoofs of horse to said foot supports. For example, the attachment device may consist of a first part attached as horseshoes to the animals hoofs and a second part for removably receiving the horseshoes so that they are attached to the foot support or pedal. Also envisioned are a cover, shock absorbers, and brakes.

As shown in FIG. 11, a method of providing an efficient, motorless personal vehicle is also disclosed, comprising the steps of: step 200 providing a frame that is supported by at least three wheels; step 202 coupling at least one foot link to at least one said wheel; step 204 providing at least four foot supports, wherein at least one foot support is in fixed communication with said foot link; step 206 providing a coupling system in rotational communication with at least one foot link to translate the stepping motion of an animal into angular momentum. The step 206 of providing a coupling system may be accomplished by providing at least one gear in communication with at least one foot link to translate and amplify angular momentum.

Depending on the size of the gears relative to one another, the gears may amplify and translate the angular momentum of one gear relative to another. It should be understood that a number of different gear types and sizes may be utilized without departing from the present invention.

It is envisioned that any enhancement device known within the art may be utilized without departing from the present invention. For example, reflectors, brake, handlebars, lights, a speedometer, an odometer may all be added to the vehicle.

It should be understood, of course, that the foregoing relates to preferred embodiments of the invention and that modifications may be made without departing from the spirit and scope of the invention as set forth in the following claims.

I claim:

1. A horse drawn ground vehicle for carrying a passenger, said vehicle comprising:
a frame configured to be supported on the ground by at least three wheels rotatably attached to said frame;
at least one foot link coupled to said at least three wheels, wherein each foot link has a first end and a second end;
at least four foot supports for receiving the hoofs of a horse in standing position, said foot supports supported by said at least one foot link;
at least one coupling system in rotational communication with at least one said foot link to translate the stepping motion of a horse into angular momentum; and
at least one seat.

2. A vehicle as in claim 1, further comprising an attachment device for removably attaching the hoofs of said horse to said foot supports.

3. A vehicle as in claim 1, further comprising a restraint system for containing said horse within said vehicle.

4. A vehicle as in claim 1, further comprising a cover that is in communication with said frame so as to protect the horse and vehicle, yet not make contact with any portion except the frame.

5. A vehicle as in claim 1, further comprising shock absorbers in communication with a portion of said frame to stabilize said frame.

6. A vehicle as in claim 1, further comprising brakes in communication with at least one wheel.

7. A vehicle as in claim 1, wherein said coupling system is comprised of at least one arm in communication with said foot support and an inducer, said inducer in communication with at least one gear to cause rotation of said at least one gear, and a chain in communication with said gear and a main axis, wherein said chain translates motion from said gear to said main axis, which in turn causes the rotation of at least one wheel.

8. A vehicle as in claim 1, wherein said coupling system is at least two arms attached to said wheel as to provide an elliptical motion of said foot supports.

9. A vehicle as in claim 1, further comprising a steering mechanism in communication with at least one said wheel.

10. A horse drawn ground vehicle for carrying a passenger, said vehicle comprising:
a frame configured to be supported on the ground by six wheels rotatably attached to said frame;
four foot links coupled to four of said six wheels, wherein each foot link has a first end and a second end;
four foot supports for receiving the hoofs of a horse in standing position, said foot supporting portion supported by said at least two foot links; and
two coupling systems in rotational communication with at least one said foot link to translate the stepping motion of a horse into angular momentum.

11. A vehicle as in claim 10, further comprising an attachment device for removably attaching the hoofs of said horse to said foot supports.

12. A vehicle as in claim 10, further comprising an aerodynamic cover.

13. A vehicle as in claim 10, further comprising a harness stabilizing system for stabilizing said horse in said horse drawn vehicle.

14. A vehicle as in claim 10, further comprising shock absorbers.

15. A horse drawn vehicle as in claim 10, further comprising brakes in communication with at least one wheel.

16. A horse drawn water vehicle for carrying a passenger, said vehicle comprising:
a frame configured to be supported on the water with at least one water pedal rotatably attached to said frame;
at least two foot links coupled to said at least one water pedal, wherein each foot link has a first end and a second end;
at least four foot supports for receiving the hoofs of a horse in standing position, said foot supports supported by said at least two foot links;
at least one coupling system in rotational communication with at least one said foot link to translate the stepping motion of a horse into angular momentum; and
at least one seat.

17. A vehicle as in claim 16, further comprising an attachment device for removably attaching the hoofs of said horse to said foot supports.

18. A vehicle as in claim 16, further comprising an aerodynamic cover.

19. A vehicle as in claim 16, further comprising a harness stabilizing system for stabilizing said horse in said horse drawn vehicle.

20. A vehicle as in claim 16, further comprising shock absorbers.

21. A horse drawn vehicle as in claim 16, further comprising brakes in communication with at least one wheel.

22. A vehicle as in claim 16, wherein said coupling system is comprised of at least one arm in communication with said foot support and an inducer, said inducer in communication with at least one gear to cause rotation of said at least one gear, and a chain in communication with said gear and a main axis, wherein said chain translates motion from said gear to said main axis, which in turn causes the rotation of at least one wheel.

23. A method of providing an efficient, motorless personal vehicle, comprising;
providing a frame, wherein said frame is supported by at least three wheels;
providing at least four foot supports, wherein at least one foot support is fixed communication with said foot link; and
providing at least one coupling system in rotational communication with at least one said foot link to translate the stepping motion of a horse into angular momentum.

24. A method as in claim 23, wherein said coupling system is comprised at least one arm in communication with said foot support and an inducer, said inducer in communication with at least one gear to cause rotation of said at least one gear, and a chain in communication with said gear and a main axis, wherein said chain translates motion from said gear to said main axis, which in turn causes the rotation of at least one wheel.

25. A method as in claim 24, further comprising the step of gear change mechanism to allow for the change of said at least one gear.
